(19) United States
(12) Patent Application Publication
(10) Pub. No.: US 2026/0229042 A1
(43) Pub. Date: Aug. 6, 2026

(54) PERSON DETECTION DEVICE, PERSON DETECTION SYSTEM, PERSON DETECTION METHOD, AND NON-TRANSITORY COMPUTER READABLE MEDIUM

(71) Applicant: NEC Corporation, Tokyo (JP)

(72) Inventors: Hisahiro OBA, Tokyo (JP); Kosuke TONO, Tokyo (JP); Masahito SAKAI, Tokyo (JP); Daisuke MORI, Tokyo (JP)

(73) Assignee: NEC Corporation, Tokyo (JP)

(21) Appl. No.: 19/155,583

(22) PCT Filed: Feb. 21, 2023
(86) PCT No.: PCT/JP2023/006230

§ 371 Date: Aug. 12, 2025

(51) Int. Cl. G06V 20/58; G06V 20/56

(52) U.S. Cl. CPC G06V 20/58; G06V 20/588; G06V 2201/07

(57) ABSTRACT

A person detection device comprises: an acquisition unit that acquires a captured video image; an object detection unit that detects a prescribed object to be detected from the video image on the basis of a threshold value of a prescribed object detection score; an adjustment unit that lowers a threshold value of a person detection score in a region of a prescribed range which includes the object to be detected in the video image to a value lower than threshold values of person detection scores in other regions; and a person detection unit that detects a person from the video image on the basis of the threshold value of the person detection score.

### TECHNICAL FIELD

The present disclosure relates to a person detection device, a person detection system, a person detection method, and a non-transitory computer readable medium.

### BACKGROUND ART

In a case where a person or the like is imaged in a video acquired by an imaging apparatus such as a drive recorder mounted on a vehicle, there is a case where masking processing is executed on a region where the person is imaged, from the viewpoint of personal information protection. In order to execute the masking processing on the region where the person is imaged, included in the video, it is required to accurately detect a person from the imaged video.

PTL 1 describes a technique for detecting a person from an image acquired by an imaging apparatus. Specifically, PTL 1 describes dividing an imaged image into a congestion region and a sparse region, acquiring a person determination threshold according to a congestion level for each region and generating a threshold map, and detecting a person by using the person determination threshold related to the region for each of the plurality of regions, based on the threshold map.

CITATION LIST

### Patent Literature

PTL 1: JP 2017-097510 A

### SUMMARY OF INVENTION

### Technical Problem

In a case where a threshold used to detect a person is lowered to improve accuracy for detecting a person from a video, there is a case where masking processing is executed on a region that is not required to be masked, in the video, which is not preferable. On the other hand, if the threshold used to detect the person is lowered, there is a possibility that the accuracy for detecting the person from the video is lowered. Although PTL 1 describes changing a person determination threshold according to a congestion level for each region, PTL 1 does not detect a person in order to execute the masking processing and cannot solve the problem.

The present disclosure has been made to solve such a problem, and an object of the present disclosure is to provide a person detection device, a person detection system, a person detection method, and a non-transitory computer readable medium that can accurately and suitably detect a person.

### Solution to Problem

A person detection device according to a first aspect of the present disclosure includes acquisition means for acquiring an imaged video, target detection means for detecting a predetermined detection target from the video based on a threshold of a predetermined target detection score, adjustment means for lowering a threshold of a person detection score in a region having a predetermined range including the detection target in the video to be lower than the threshold of the person detection score in another region, and person detection means for detecting a person from the video based on the threshold of the person detection score.

A person detection system according to a second aspect of the present disclosure includes an imaging apparatus that is provided in a vehicle and images a video around the vehicle and a person detection device communicable with the imaging apparatus, in which the person detection device includes acquisition means for acquiring a video imaged by the imaging apparatus, target detection means for detecting a predetermined detection target from the video based on a threshold of a predetermined target detection score, adjustment means for lowering a threshold of a person detection score in a region having a predetermined range including the detection target in the video to be lower than the threshold of the person detection score in another region, and person detection means for detecting a person from the video based on the threshold of the person detection score.

A person detection method according to a third aspect of the present disclosure is a method performed by a computer, including acquiring an imaged video, detecting a predetermined detection target from the video based on a threshold of a predetermined target detection score, lowering a threshold of a person detection score in a region having a predetermined range including the detection target in the video to be lower than the threshold of the person detection score in another region, and detecting a person from the video based on the threshold of the person detection score.

A non-transitory computer readable medium according to a fourth aspect of the present disclosure, stores a person detection program for causing a computer to execute processing including acquiring an imaged video, detecting a predetermined detection target from the video based on a threshold of a predetermined target detection score, lowering a threshold of a person detection score in a region having a predetermined range including the detection target in the video to be lower than the threshold of the person detection score in another region, and detecting a person from the video based on the threshold of the person detection score.

### ADVANTAGEOUS EFFECTS OF INVENTION

It is possible to provide a person detection device, a person detection system, a person detection method, and a non-transitory computer readable medium that can accurately and suitably detect a person.

### BRIEF DESCRIPTION OF DRAWINGS

FIG. 1 is a block diagram illustrating a configuration of a person detection device according to a first example embodiment.

FIG. 2 is a diagram illustrating an example of a video acquired by an acquisition unit according to the first example embodiment.

FIG. 3 is a flowchart illustrating a person detection method according to the first example embodiment.

FIG. 4 is a block diagram illustrating a configuration of a person detection system according to a second example embodiment.

FIG. 5 is a block diagram illustrating a configuration of a person detection device according to the second example embodiment.

FIG. 6 is a diagram illustrating an example of a video acquired by an acquisition unit according to the second example embodiment.

FIG. 7 is a flowchart illustrating a person detection method according to the second example embodiment.

FIG. 8 is a block diagram illustrating a configuration of a person detection device according to a third example embodiment.

FIG. 9 is a diagram illustrating an example of a video acquired by an acquisition unit according to the third example embodiment.

FIG. 10 is a flowchart illustrating a person detection method according to the third example embodiment.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description.

### First Example Embodiment

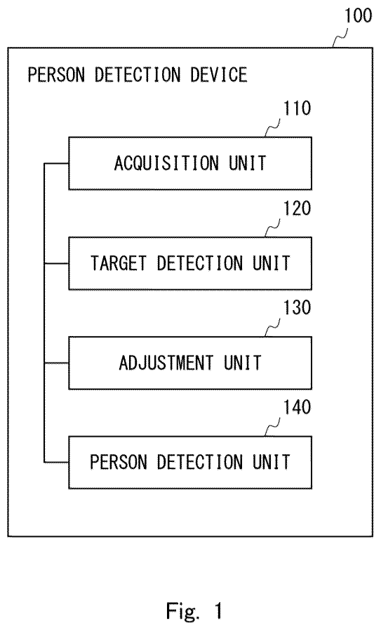

FIG. 1 is a block diagram illustrating a configuration of a person detection device 100 according to a first example embodiment. The person detection device 100 includes an acquisition unit 110 as acquisition means, a target detection unit 120 as target detection means, an adjustment unit 130 as adjustment means, and a person detection unit 140 as person detection means. The person detection device 100 is connected to a network 500 (not illustrated). The network 500 may be a wired network or a wireless network. An imaging apparatus 310 (not illustrated) or the like is connected to the network 500. The imaging apparatus 310 is an apparatus that is provided in a vehicle 300 (not illustrated) and images surroundings of the vehicle 300. A video imaged by the imaging apparatus 310 is a moving image and includes a plurality of consecutive frames arranged in order of elapse of an imaging time. Here, the frame is still image data imaged by the imaging apparatus 310.

The acquisition unit 110 acquires the video imaged by the imaging apparatus 310 provided in the vehicle 300. It is assumed that the video include a plurality of frames. The video imaged by the imaging apparatus 310 is transmitted from the imaging apparatus 310 to the person detection device 100, via the network 500. The video acquired by the acquisition unit 110 may be a video acquired by an imaging apparatus other than the imaging apparatus 310 provided in the vehicle 300, such as a monitoring camera.

The target detection unit 120 detects a predetermined detection target from the video acquired by the acquisition unit 110, based on a threshold of a predetermined target detection score. Here, as the predetermined detection target, a moving body such as a two-wheeled vehicle or a four-wheeled vehicle is exemplified. In the first example embodiment, the two-wheeled vehicle is exemplified and described as an example of the predetermined detection target. Specifically, the target detection unit 120 detects a two-wheeled vehicle for each frame included in the video, based on a threshold of a two-wheeled vehicle detection score as the predetermined target detection score. The target detection unit 120 detects the two-wheeled vehicle, by using a trained two-wheeled vehicle detection model (not illustrated). The two-wheeled vehicle detection score is a score calculated by the target detection unit 120, for each detection frame region having a predetermined size (for example, M×N pixels (M and N are integers of two or more)), from the frame, by using the two-wheeled vehicle detection model. The two-wheeled vehicle detection score has a higher numerical value in a region having a high possibility that a two-wheeled vehicle exists, than another region. A threshold of the predetermined two-wheeled vehicle detection score is a preset numerical value and is used in a case where the two-wheeled vehicle is detected from the frame included in the video. In a case where a two-wheeled vehicle detection score in a region of a frame is equal to or more than the threshold of the two-wheeled vehicle detection score, the target detection unit 120 determines that the two-wheeled vehicle exists in the region. Here, the two-wheeled vehicle is a motorcycle, a bicycle, an electric scooter, or the like. Here, although machine learning may be deep learning, machine learning is not particularly limited. A method for calculating the two-wheeled vehicle detection score is not limited to the above, and other existing techniques can be applied.

In a case where the target detection unit 120 detects the two-wheeled vehicle from the frame included in the video, the adjustment unit 130 lowers a threshold of a person detection score in a region having a predetermined range including the two-wheeled vehicle in the frame. Here, the predetermined range is a range of a predetermined size appropriately set according to an object of person detection.

The person detection unit 140 detects a person from the video acquired by the acquisition unit 110, based on the threshold of the predetermined person detection score. Specifically, the person detection unit 140 detects the person for each frame included in the video. The person detection unit 140 detects the person, by using a trained person detection model (not illustrated). The person detection score is a score calculated by the person detection unit 140, for each detection frame region having a predetermined size (for example, M×N pixels (M and N are integers of two or more)), from the frame, by using the person detection model. The person detection score has a higher numerical value in a region having a high possibility that a person exists, than another region. The threshold of the predetermined person detection score is a preset numerical value and is used in a case where the person is detected from the frame included in the video. The threshold of the person detection score may be set to a value different according to the region in the frame. Specifically, the threshold of the person detection score is adjusted by the adjustment unit 130, in a predetermined case. In a case where the person detection score in the region in the frame is equal to or more than the threshold of the person detection score, the person detection unit 140 determines that a person is imaged in the region. A method for calculating the person detection score is not limited to the above, and other existing techniques can be applied.

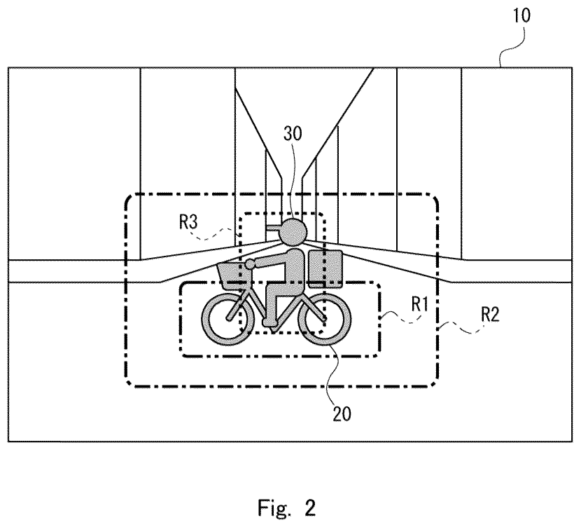

FIG. 2 illustrates an example of a frame 10 included in the video acquired by the acquisition unit 110. In the frame 10 illustrated in FIG. 2, a person 30 on a bicycle 20 is imaged. In the example illustrated in FIG. 2, the target detection unit 120 detects the bicycle 20 as a two-wheeled vehicle. In FIG. 2, a region R1 related to the bicycle 20 detected by the target detection unit 120 is indicated by an alternate long and two short dashes line. Next, the adjustment unit 130 lowers the threshold of the person detection score, in a region R2 having a predetermined range including the region R1. In FIG. 2, the region R2 having the predetermined range is indicated by a dotted and dashed line. Next, the person detection unit 140 detects a person from the frame. Since the threshold of the person detection score in the region R2 is lowered below a threshold of a person detection score in another region, it is easier to detect a person in the region R2 than the another region. In FIG. 2, a region R3 related to the person 30 detected by the person detection unit 140 is indicated by a broken line.

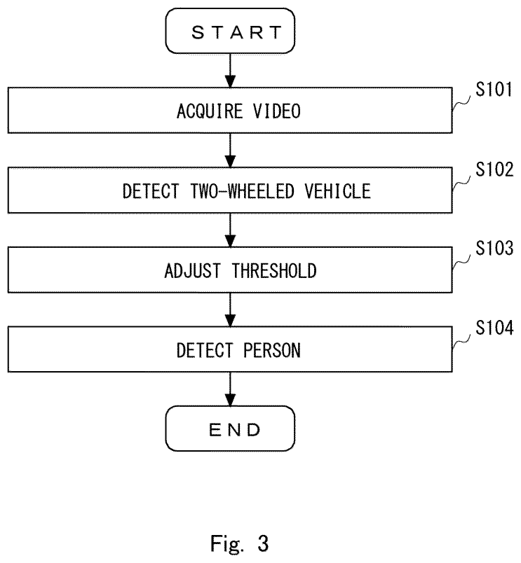

Next, a person detection method according to the first example embodiment will be described with reference to FIG. 3. First, the acquisition unit 110 acquires a video imaged by an imaging apparatus (step S101). Next, the target detection unit 120 detects a two-wheeled vehicle from a frame included in the video based on the threshold of the predetermined two-wheeled vehicle detection score (step S102). Next, the adjustment unit 130 adjusts the threshold of the person detection score (step S103). Specifically, in a case where the two-wheeled vehicle is detected from the video, the adjustment unit 130 lowers the threshold of the person detection score in the region R2 having the predetermined range including the two-wheeled vehicle in the frame. Next, the person detection unit 140 detects a person from the frame included in the video based of the threshold of the predetermined person detection score (step S104). Here, the threshold of the person detection score in the region R2 having the predetermined range including the two-wheeled vehicle is lower than the threshold of the person detection score in the another region. Therefore, the person detection unit 140 can accurately detect the person 30 on the two-wheeled vehicle 20. As a result, it is possible to accurately detect the person 30 in the region R2 including the two-wheeled vehicle 20 and execute masking processing from the viewpoint of personal information protection. At the same time, it is possible to avoid an inconvenience such that a person is erroneously detected in a region other than the region R2 including the two-wheeled vehicle 20 and the masking processing is executed.

In this way, since the person detection device 100 according to the present example embodiment lowers the threshold of the person detection score in the region with a high possibility that a person is imaged (the region R2 with the predetermined range including the two-wheeled vehicle) and detect the person, the person detection device 100 can accurately detect the person. In addition, because it is not possible to lower the threshold of the person detection score in a region with a low possibility that a person is imaged (the region other than the region R2 including the two-wheeled vehicle 20), it is possible to avoid an inconvenience that the person is erroneously detected in the region. Therefore, the person detection device 100 according to the present example embodiment can accurately and suitably detect the person.

The person detection device 100 includes a processor, a memory, and a storage apparatus as components not illustrated. In addition, the storage apparatus stores a computer program in which processing of the person detection method according to the present example embodiment is implemented. Then, the processor reads the computer program from the storage apparatus into the memory and executes the computer program. As a result, the processor achieves functions as the acquisition unit 110, the target detection unit 120, the adjustment unit 130, and the person detection unit 140.

Alternatively, each of the acquisition unit 110, the target detection unit 120, the adjustment unit 130, and the person detection unit 140 may be achieved by dedicated hardware. Some or all of the components of each apparatus may be achieved by a general-purpose or dedicated circuitry, a processor, or a combination thereof. These components may be configured with a single chip or may be configured with a plurality of chips connected via a bus. Some or all of the components of each apparatus may be achieved by a combination of the above-described circuitry or the like and a program. A central processing unit (CPU), a graphics processing unit (GPU), a field-programmable gate array (FPGA), or the like can be used as the processor.

In addition, in a case where some or all of the components of the person detection device 100 are achieved by a plurality of information processing apparatuses, circuits, and the like, the plurality of information processing apparatuses, circuits, and the like may be disposed in a centralized manner or in a distributed manner. For example, the information processing apparatuses, the circuits, or the like may be achieved in the form of a client server system, a cloud computing system, or the like in which they are connected to each other through a communication network. A function of the person detection device 100 may be provided in a form of a Software as a Service (Saas) format.

### Second Example Embodiment

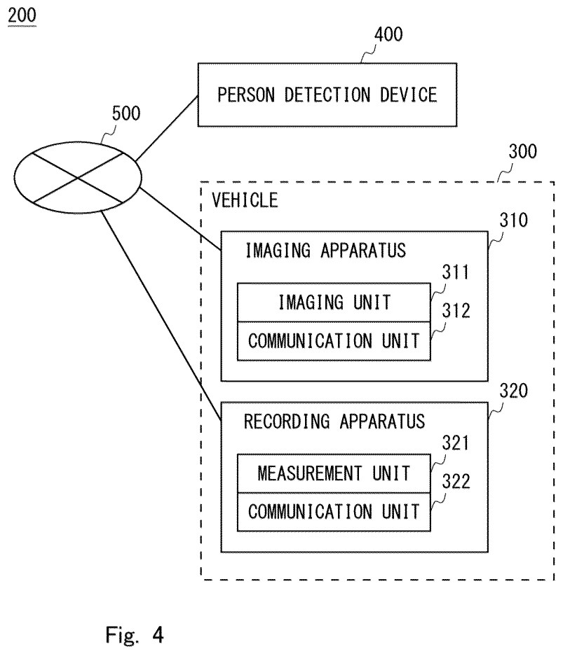

FIG. 4 is a block diagram illustrating a configuration of a person detection system 200 according to a second example embodiment. The person detection system 200 includes at least an imaging apparatus 310 and a person detection device 400 and may further include a recording apparatus 320. Each of the imaging apparatus 310 and the recording apparatus 320 is connected to the person detection device 400 via a network 500. Description overlapping with the first example embodiment will be omitted as appropriate.

The person detection system 200 is a system that detects a person from a video imaged in a vehicle 300. The vehicle 300 is, for example, an automobile and may be a vehicle other than an automobile such as a motorcycle or a bicycle. The imaging apparatus 310 and the recording apparatus 320 are provided in the vehicle 300. The imaging apparatus 310 is an apparatus that images a scene around the vehicle 300 and is, for example, a drive recorder. The imaging apparatus 310 includes an imaging unit 311 and a communication unit 312. The imaging unit 311 is a camera. The imaging unit 311 images, for example, a scene in front of the vehicle 300, that is, a scene that a driver sitting on a driver's seat of the vehicle 300 can see. The communication unit 312 is a communication interface with the network 500. The communication unit 312 transmits the video imaged by the imaging unit 311 to the person detection device 400, via the network 500.

The recording apparatus 320 is an apparatus that records a traveling speed of the vehicle 300. The recording apparatus 320 includes a measurement unit 321 and a communication unit 322. The measurement unit 321 measures the traveling speed of the vehicle 300. The communication unit 322 is a communication interface with the network 500. The communication unit 322 transmits speed information including a speed measured by the measurement unit 321 to the person detection device 400, via the network 500.

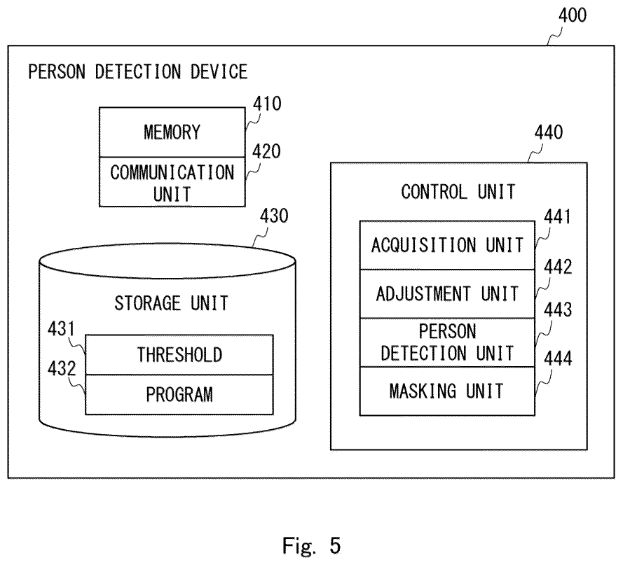

Next, a configuration of the person detection device 400 will be described in detail, with reference to FIG. 5. FIG. 5 is a block diagram illustrating the configuration of the person detection device 400. The person detection device 400 includes a memory 410, a communication unit 420, a storage unit 430, and a control unit 440.

The memory 410 is a storage region for temporarily storing processing contents of the control unit 440, and is, for example, a volatile storage device such as a random access memory (RAM). The communication unit 420 is an interface that communicates with outside of the person detection device 400.

The storage unit 430 is a storage apparatus that stores a threshold 431 of a person detection score, a program 432, or the like. The threshold 431 of the person detection score is a numerical value used in a case where a person is detected from a frame included in the video, and a different value may be set according to a region in the frame. Specifically, the threshold of the person detection score is adjusted by an adjustment unit 442, in a predetermined case. The program 432 is a computer program in which person detection processing according to the present example embodiment is implemented.

The control unit 440 includes an acquisition unit 441, the adjustment unit 442, a person detection unit 443, and a masking unit 444. The control unit 440 is a control apparatus that controls an operation of the person detection device 400 and is, for example, a processor such as a CPU. The control unit 440 reads the program 432 from the storage unit 430 into the memory 410 and executes the program 432. As a result, the control unit 440 achieves functions as the acquisition unit 441, the adjustment unit 442, the person detection unit 443, and the masking unit 444.

The acquisition unit 441 acquires the video transmitted from the imaging apparatus 310. The video includes a plurality of consecutive frames. In addition, the video may include identification information, time information, or the like. The identification information is information for identifying the vehicle 300 in which the imaging apparatus 310 that images the video is provided. The time information is information regarding a time when the video is imaged. Moreover, the acquisition unit 441 may acquire the speed information transmitted from the recording apparatus 320. The speed information includes at least information regarding the traveling speed of the vehicle 300 and may further include the identification information and the time information. The time information included in the speed information is information regarding a time when the traveling speed is recorded.

The adjustment unit 442 lowers the threshold of the person detection score in a peripheral region of the frame included in the video. That is, the threshold of the person detection score in the peripheral region of the frame is lower than a threshold of the person detection score in a central region that is a region other than the peripheral region. Here, the central region is a region appropriately set according to an object of person detection and is a range having a predetermined size including a center of the frame. The center of the frame and the center of the central region may or does not need to coincide with each other.

The person detection unit 443 detects a person from the video acquired by the acquisition unit 441. Specifically, the person detection unit 443 calculates the person detection score, for each frame included in the video acquired by the acquisition unit 441. Since a method for calculating the person detection score by the person detection unit 443 is similar to that of the person detection unit 140, description thereof is omitted. Next, the person detection unit 443 determines whether the calculated person detection score is equal to or more than the threshold 431 of the person detection score. The person detection unit 443 calculates and determines the person detection score for each of the plurality of frames. The threshold 431 of the person detection score is a preset numerical value and is used in a case where the person is detected from the frame included in the video. The threshold 431 of the person detection score may be set to a value different according to the region in the frame. Specifically, the threshold 431 of the person detection score is adjusted by the adjustment unit 442, in a predetermined case. The person detection unit 443 determines that the person is imaged in a portion where the person detection score is equal to or more than the threshold 431 of the person detection score in the frame.

The masking unit 444 executes masking processing on a region in the frame related to the person detected by the person detection unit 443. Here, the masking processing is image processing executed on the region so as not to identify the person and includes solid coating processing, filter processing, or the like. The masking unit 444 may execute the masking processing on a part of the region related to the person in the frame (for example, a portion related to face).

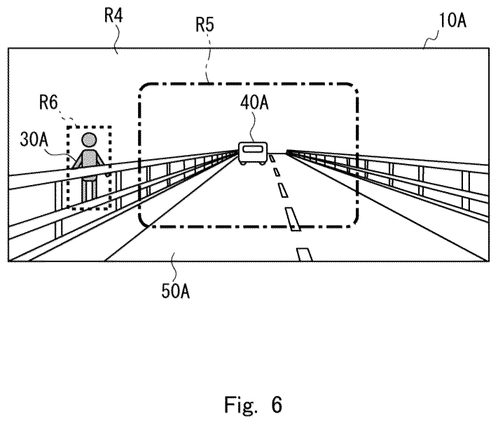

FIG. 6 illustrates an example of a frame 10A included in the video acquired by the acquisition unit 441. In the frame 10A illustrated in FIG. 6, a person 30A and a vehicle 40A traveling forward on a roadway 50A are imaged. In the example illustrated in FIG. 6, the adjustment unit 442 lowers the threshold 431 of the person detection score in a peripheral region R4. In FIG. 6, a central region R5 that is a region other than the peripheral region R4 is indicated by a dotted and dashed line. Next, the person detection unit 443 detects a person from the frame. Since the threshold 431 of the person detection score in the peripheral region R4 is lowered below the threshold 431 of the person detection score in the central region R5, it is easier to detect the person in the peripheral region R4 than the central region R5. In FIG. 6, a region R6 related to the person 30A detected by the person detection unit 443 is indicated by a broken line.

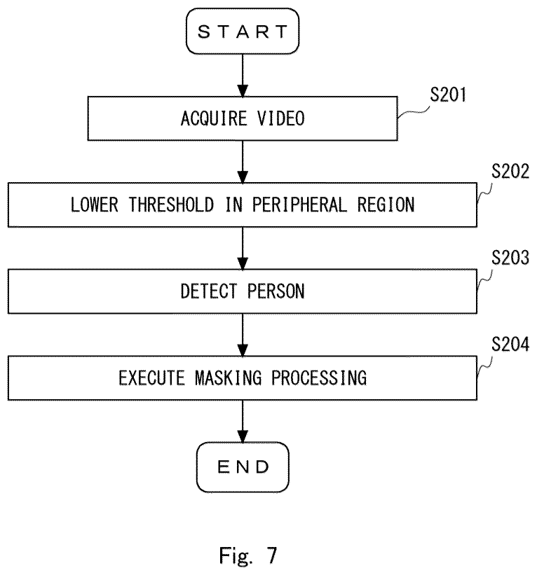

Next, a person detection method according to the second example embodiment will be described, with reference to FIG. 7. First, the acquisition unit 441 acquires the video transmitted from the imaging apparatus 310 (step S201). Next, the adjustment unit 442 lowers the threshold 431 of the person detection score in the peripheral region R4 (step S202). Next, the person detection unit 443 detects a person from the frame included in the video based on a threshold of a predetermined person detection score (step S203). Next, the masking unit 444 executes the masking processing on a region related to the person in the frame (step S204). Here, the threshold of the person detection score in the peripheral region R4 is lower than the threshold of the person detection score in the central region R5. Therefore, the person detection unit 443 can more accurately detect the person 30A in the peripheral region R4 than the central region R5. As a result, it is possible to accurately detect the person 30A in the peripheral region R4 and execute the masking processing, and it is also possible to avoid an inconvenience that the person is erroneously detected in the central region R5 and the masking processing is executed.

In this way, since the person detection device 400 according to the present example embodiment lowers the threshold of the person detection score in a region with a high possibility that a person is imaged (the peripheral region R4) and detect the person, the person detection device 400 can accurately detect the person. In addition, because it is not possible to lower the threshold of the person detection score in a region with a low possibility that a person is imaged (the central region R5), it is possible to avoid an inconvenience that the person is erroneously detected in the region R5. Therefore, the person detection device 400 according to the present example embodiment can accurately and suitably detect a person.

### Third Example Embodiment

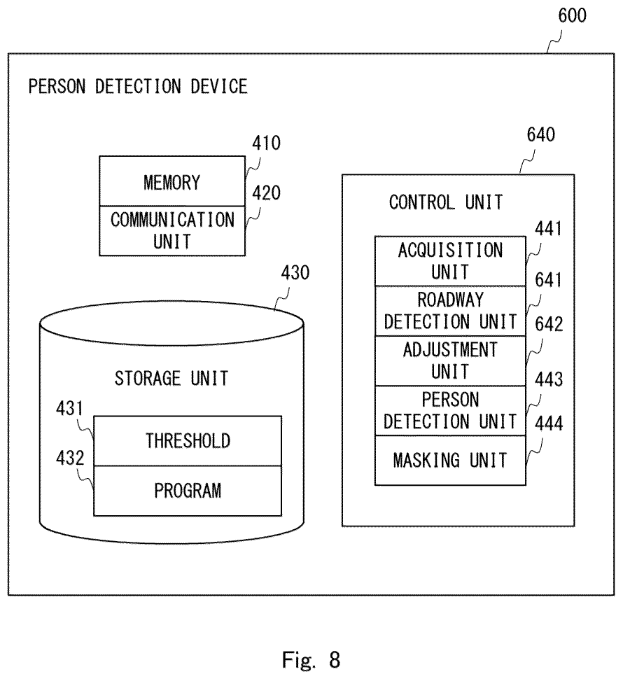

FIG. 8 is a block diagram illustrating a configuration of a person detection device 600 according to a third example embodiment. The person detection device 600 is different from the person detection device 400 illustrated in FIG. 5 in that a control unit 640 is included instead of the control unit 440. The control unit 640 has configurations of a roadway detection unit 641 and an adjustment unit 642 different from the respective configurations included in the control unit 440. Therefore, since configurations of the acquisition unit 441, the person detection unit 443, and the masking unit 444 of the control unit 640 overlap with those of the second example embodiment, the description thereof is omitted as appropriate.

The control unit 640 includes the acquisition unit 441, the roadway detection unit 641 as roadway detection means, the adjustment unit 642, the person detection unit 443, and the masking unit 444. The acquisition unit 441 acquires a video from an imaging apparatus 310 and may further acquire speed information from a recording apparatus 320. The person detection unit 443 detects a person based on a threshold of a person detection score, for each of a plurality of frames included in the video acquired by the acquisition unit 441. The masking unit 444 executes masking processing on a region in the frame related to the person detected by the person detection unit 443.

The roadway detection unit 641 detects a roadway from the video acquired by the acquisition unit 441, based on a threshold of a predetermined roadway detection score. Specifically, the roadway detection unit 641 detects a roadway for each frame included in the video. The roadway detection unit 641 detects the roadway, by using a trained roadway detection model (not illustrated). The roadway detection score is a score calculated by the roadway detection unit 641, for each region having a predetermined size in the frame, using the roadway detection model. The roadway detection score has a higher numerical value in a region having a high possibility that a roadway exists, than another region. The threshold of the predetermined roadway detection score is a preset numerical value and is used in a case where the roadway is detected from the frame included in the video. In a case where the roadway detection score in a region in the frame is equal to or more than the threshold of the roadway detection score, the roadway detection unit 641 determines that the roadway exists in the region. Here, the roadway is a portion of a road intended exclusively for passage of vehicles (excluding a bicycle roadway) and includes a road shoulder, a side strip, and a car-track lane. A method for calculating the roadway detection score is not limited to the above, and other existing techniques can be applied.

In a case where the roadway detection unit 641 detects the roadway from the frame included in the video, the adjustment unit 642 lowers the threshold of the person detection score in a region other than the region related to the roadway in the frame. That is, the threshold of the person detection score in the region other than the region related to the roadway of the frame is lower than the threshold of the person detection score in the region related to the roadway.

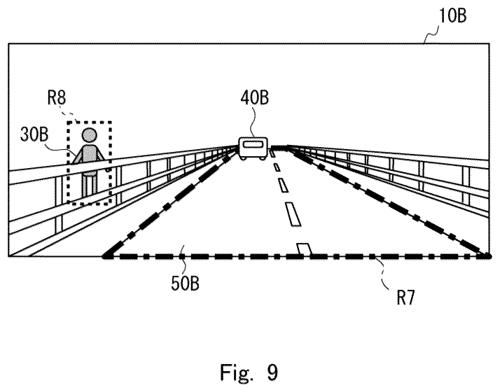

FIG. 9 illustrates an example of a frame 10B included in the video acquired by the acquisition unit 441. In the frame 10B illustrated in FIG. 9, a person 30B, a vehicle 40B traveling forward, and a roadway 50B on which the vehicle 40B travels are imaged. In the example illustrated in FIG. 9, the roadway detection unit 641 detects the roadway 50B. In FIG. 9, a region R7 related to the roadway 50B detected by the roadway detection unit 641 is indicated by a dotted and dashed line. Next, the adjustment unit 642 lowers the threshold 431 of the person detection score in a region other than the region R7. Next, the person detection unit 443 detects a person from the frame. Since the threshold 431 of the person detection score in the region other than the region R7 is lowered below the threshold 431 of the person detection score in the region R7, it is easier to detect a person in the region other than the region R7, than the region R7. In FIG. 9, a region R8 related to the person 30B detected by the person detection unit 443 is indicated by a broken line.

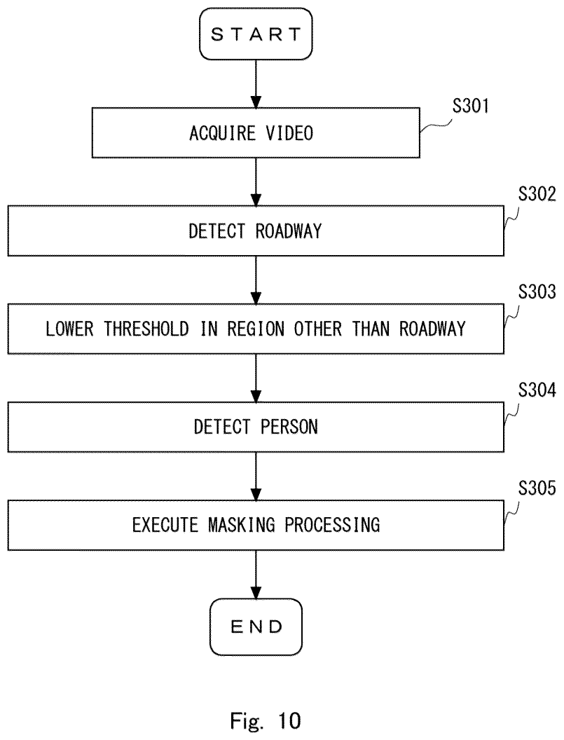

Next, a person detection method according to the third example embodiment will be described, with reference to FIG. 10. First, the acquisition unit 441 acquires the video transmitted from the imaging apparatus 310 (step S301). Next, the roadway detection unit 641 detects the roadway from the frame included in the video based on the threshold of the predetermined roadway detection score (step S302). Next, the adjustment unit 642 lowers the threshold 431 of the person detection score in the region other than the region R7 related to the roadway in the frame (step S303). Next, the person detection unit 443 detects a person from the frame included in the video based on the threshold of the predetermined person detection score (step S304). Next, the masking unit 444 executes the masking processing on a region related to the person in the frame (step S305). Here, the threshold of the person detection score in the region other than the region R7 related to the roadway is lower than the threshold of the person detection score in the region R7. Therefore, the person detection unit 443 can accurately detect the person 30A in the region other than the region R7 related to the roadway, than the region R7. As a result, it is possible to accurately detect the person 30A in the region other than the region R7 related to the roadway and execute the masking processing, and it is possible to avoid an inconvenience that the person is erroneously detected in the region R7 and the masking processing is executed.

In this way, since the person detection device 600 according to the present example embodiment lowers the threshold of the person detection score in a region with a high possibility that a person is imaged (the region other than the region R7 related to the roadway) and detect the person, the person can be accurately detected. In addition, because it is not possible to lower the threshold of the person detection score in a region with a low possibility that a person is imaged (the region R7 related to the roadway), it is possible to avoid an inconvenience that the person is erroneously detected in the region R7. Therefore, the person detection device 600 according to the present example embodiment can accurately and suitably detect a person.

In the above-described example embodiments, the configuration of the hardware has been described, but the present disclosure is not limited thereto. According to the present disclosure, the above-described processing illustrated in FIGS. 3, 7, and 10 can also be achieved by causing a CPU to execute a computer program.

In the above-described example, the program can be stored using various types of non-transitory computer readable medium and supplied to a computer. The non-transitory computer readable media include various types of tangible storage media. Examples of the non-transitory computer readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and a semiconductor memory (for example, a mask ROM, a programmable ROM (PROM), an erasable PROM (EPROM), a flash ROM, or a random access memory (RAM)). The program may be supplied to the computer by various types of transitory computer readable media. Examples of transitory computer readable media include electrical signals, optical signals, and electromagnetic waves. The transitory computer readable media can supply the programs to the computer via a wired communication path such as an electric wire and an optical fiber or a wireless communication path.

Note that the present disclosure is not limited to the above-described example embodiments, and can be appropriately changed without departing from the scope. The present disclosure may be implemented by appropriately combining the example embodiments. The functions of the target detection unit 120, the adjustment unit 130, and the person detection unit 140 of the person detection device 100 may be mounted on the imaging apparatus 310 of each vehicle 300. Similarly, the functions of the adjustment unit 442, the person detection unit 443, and the masking unit 444 of the person detection device 400 may be mounted on the imaging apparatus 310 of each vehicle 300. Similarly, the functions of the roadway detection unit 641, the adjustment unit 642, the person detection unit 443, and the masking unit 444 of the person detection device 600 may be mounted on the imaging apparatus 310 of each vehicle 300. As a result, the imaging apparatus 310 of each vehicle 300 can individually detect a person and execute masking processing.

While the present invention has been particularly shown and described with reference to example embodiments, the present invention is not limited to these example embodiments. It will be understood by those of ordinary skill in the art that various changes in form and details may be made therein without departing from the spirit and scope of the present invention as defined by the claims.

### REFERENCE SIGNS LIST

10, 10A, 10B frame

20 bicycle (two-wheeled vehicle)

30, 30A, 30B person

40A, 40B vehicle

50A, 50B roadway

100, 400, 600 person detection device

410 memory

420 communication unit

430 storage unit

431 threshold

440, 640 control unit

110, 441 acquisition unit (acquisition means)

120 target detection unit (target detection means)

641 roadway detection unit (roadway detection means)

130, 442, 642 adjustment unit (adjustment means)

140, 443 person detection unit (person detection means)

444 masking unit

200 person detection system

300 vehicle

310 imaging apparatus

311 imaging unit

312 communication unit

320 recording apparatus

321 measurement unit

322 communication unit

500 network

R1, R2, R3, R4, R5, R6, R7, R8 region

What is claimed is:

1. A person detection device comprising:
a memory storing instructions; and
one or more processors configured to execute the instructions to:
acquire an imaged video;
detect a predetermined detection target from the video based on a threshold of a predetermined target detection score;
adjust a threshold of a person detection score in a region having a predetermined range including the detection target in the video to be lower than the threshold of the person detection score in another region; and
person detect a person from the video based on the threshold of the person detection score.

2. The person detection device according to claim 1, wherein the detection target includes at least a two-wheeled vehicle.

3. The person detection device according to claim 1, the one or more processors configured to further execute the instructions to detect a roadway from the video,
wherein the one or more processors adjust the threshold of the person detection score in a region related to a portion other than the roadway in the video to be lower than the threshold of the person detection score in a region related to the roadway.

4-5. (canceled)

6. A person detection method performed by a computer, comprising:
acquiring an imaged video;
detecting a predetermined detection target from the video based on a threshold of a predetermined target detection score;
lowering a threshold of a person detection score in a region having a predetermined range including the detection target in the video to be lower than the threshold of the person detection score in another region; and
detecting a person from the video based on the threshold of the person detection score.

7. The person detection method according to claim 6, performed by the computer, further comprising:
detecting a roadway from the video; and
lowering the threshold of the person detection score in a region related to a portion other than the roadway in the video to be lower than the threshold of the person detection score in a region related to the roadway.

8. A non-transitory computer readable medium storing a person detection program for causing a computer to execute processing comprising:
acquiring an imaged video;
detecting a predetermined detection target from the video based on a threshold of a predetermined target detection score;
lowering a threshold of a person detection score in a region having a predetermined range including the detection target in the video to be lower than the threshold of the person detection score in another region; and
detecting a person from the video based on the threshold of the person detection score.

9. The non-transitory computer readable medium according to claim 8, storing the person detection program for causing the computer to execute processing comprising:
further detecting a roadway from the video; and
lowering the threshold of the person detection score in a region related to a portion other than the roadway in the video to be lower than the threshold of the person detection score in a region related to the roadway.
